(19) United States
(12) Patent Application Publication
(10) Pub. No.: US 2002/0156657 A1
(43) Pub. Date: Oct. 24, 2002

(54) Insurance renewal system and method

(76) Inventors: Kurt M. de Grosz, Burlingame, CA (US); Brian W. Bair, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/008,951

(22) Filed: Dec. 5, 2001

Related U.S. Application Data
(60) Provisional application No. 60/251,754, filed on Dec. 5, 2000.
(60) Provisional application No. 60/251,703, filed on Dec. 5, 2000.
(60) Provisional application No. 60/251,708, filed on Dec. 5, 2000.

(51) Int. Cl. G06F 17/60

(52) U.S. Cl. 705/4

(57) ABSTRACT

The present invention provides system and methods for renewing benefit products. The system comprises a renewal module for sending a carrier a renewal request having an available plan, wherein the carrier updates plan information to generate a renewed plan accessible by a broker. The system has a database for closing the renewal request and archiving the renewed plan.

### CROSS-REFERENCES TO RELATED APPLICATIONS

This application claims priority to U.S. Provisional Patent Application Nos. 60/251,754, 60/251,754, 60/251,703 and 60/251,708, all of which were filed on Dec. 5, 2000, the disclosures are hereby incorporated by reference in their entireties for all purposes.

### BACKGROUND OF THE INVENTION

Healthcare is a $900 billion to 1 trillion dollar market characterized by tremendous inefficiencies that account for upwards of $250 billion in unnecessary expenditures. The employee benefits industry is dominated by a highly inefficient distribution system. A paper-based, labor-intensive distribution process contributes to health plan expense ratios that often exceed 20% of premiums. Long sales cycles, redundant data entry, and excessive paper handling results in inaccurate case installations, poor customer service and, ultimately, low customer satisfaction and retention.

The healthcare and insurance industries have done little to correct these inefficiencies. Several factors explain this inaction. First, the insurance industry historically has placed more emphasis on pricing than cost cutting in determining profitability, hence decades of hard and soft market cycles. Second, insurer focus on propriety has resulted in isolated legacy systems and a lack of product and electronic standards, hence an industry that is much less automated than other service industries such as financial services. Third, insurers have been reluctant to push change on the broker distribution channel for fear of alienating the very entities that control the local, relationship-based healthcare insurance business.

These challenges are attracting billions of dollars from people and businesses that view healthcare and insurance as vertical markets ripe for radical transformation. Generally, the first movers in this space have focused on one of three main areas: creating an electronic insurance marketplace (e.g., InsWeb, InsureMarket, ChannelPoint, eHealthinsurance, Quotesmith), developing benefits administration solutions (e.g., Healtheon, Employease, Bentana, BisNet), or delivering employee communication tools and content (e.g., Authoria, Enwisen, Workscape) The entities creating an electronic insurance marketplace focus primarily on individual products, including auto, home, life, and health. Some, like InsWeb and ChannelPoint, focus on small group as well. Whereas non-complex, commodity insurance products make sense for direct distribution over the web, more complex products such as those that make up a typical group benefits package, will continue to require the involvement of an intermediary or consultant. The entities developing benefits administration solutions in order to simplify employee communications and eligibility maintenance, are attacking the symptoms and not the source of the problems. As mentioned above, the source of the problems of high costs, inaccuracies, and poor customer service, is the distribution process itself. The entities delivering just employee communication tools and content are not associated with or linked to transactions, and therefore are at risk of losing out to product distribution entities that can deliver content and employee communication tools integrated with the transaction and distribution processes.

Healthcare insurance benefits are generally acquired for most employees through their employers. Annually, the employer negotiates new plans, benefits and purchase prices from insurance carriers. This annual process for conducting such negotiating is arduous and involves multiple carriers submitting price quotes, and plan coverages to the employer for subsequent analysis and price comparison.

U.S. Pat. No. 6,078,890, which issued to Mangin et al., discloses a method for automated collection and processing of healthcare coverage. This non-internet method uses an electronic request having an immutable format and locked embedded formulas to perform necessary calculations. The broker is eliminated in this method and thus an important aspect of the renewal function is no longer a part of the process.

In view of the foregoing, there is a need for an on-line system and method for renewal of benefits for employer groups. A need exists for a comprehensive on-line renewal method which includes broker input. The present invention fulfills these and other needs.

### SUMMARY OF THE INVENTION

The present invention provides systems and methods for on-line renewal of benefits. Advantageously, the methods and systems of the present invention allow brokers to easily track the status of renewals and to delivery a renewal request to carriers using various options.

The system and methods of the present invention have at least two ways for a “renewal request” to be created and delivered to a carrier, i.e., the system-generated request and the broker created request. The system-generated requests utilize “My Contacts” to identify recipients of the request and deliver information to a carrier. The broker created requests allow the broker to customize the requests and the information included therein. In certain aspects, “My Contacts” is a list of contacts that a broker stores in a location. Both system-generated and broker created renewals use “My Contacts” to pre-populate the e-mail addresses for the carrier recipients who receive the renewal request.

As such, the present invention provides a computer-implemented method (e.g., internet method), for renewing a benefit product. The method includes providing a carrier with a “renewal request” for a current benefit plan, wherein the current plan includes for example, current plan information such as a benefit summary, plan information, eligibility rules, rates and messages. The method includes a carrier responding to a broker by providing a renewed plan including for example, updated plan information, updated rate information, or no changes at all. The method further includes a broker saving the renewed plan in a system database, thereby archiving the current plan and renewing the benefit product. In one aspect, the renewed plan stays a “pending plan” and after a time period (e.g., 30 days) becomes activated as the renewed plan and the current plan becomes archived.

Suitable benefit products include, but are not limited to, medical insurance, dental insurance, vision insurance, life insurance, health insurance and the like.

In another embodiment, the present invention provides a system for renewing a benefit product, comprising: a renewal module for sending a carrier a renewal request having a current plan having plan information, wherein the carrier renews the current plan by updating the plan information to generate a renewed plan accessible by a broker. The system also includes a system database coupled to the renewal module for closing the renewal request, making effective the renewed plan and archiving the current plan.

Numerous benefits are achieved by way of the present invention over conventional techniques. For example, the present invention provides efficient computer implemented systems and methods to replace the arduous annual process for conducting negotiations among multiple insurance carriers. Analysis and price comparison of plan coverages for the broker and employer is greatly simplified.

Various additional objects, features and advantages of the present invention can be more filly appreciated with reference to the detailed description and accompanying drawings that follow.

### BRIEF DESCRIPTION OF THE DRAWINGS

FIG. 1A is a simplified diagram of a networked environment for the employee benefits industry according to an embodiment of the present invention;

FIG. 1B is a diagram of one embodiment of a networked environment for the employee benefits industry according to an embodiment of the present invention;

FIG. 2 is a simplified diagram of computing modules for processing information according to an embodiment of the present invention;

FIGS. 3A-B illustrate (A) a simplified flow diagram for systems and methods according to an embodiment of the present invention; (B) a web page according to an embodiment of the present invention;

FIG. 4 is a simplified flow diagram for systems and methods according to embodiments of the present invention;

FIG. 5 is a simplified flow diagram for systems and methods according to embodiments of the present invention;

FIG. 6 is a simplified flow diagram for systems and methods according to embodiments of the present invention;

FIG. 7 is a simplified flow diagram for systems and methods according to embodiments of the present invention;

FIG. 8 is a simplified flow diagram for systems and methods according to embodiments of the present invention;

FIG. 9 illustrates an exemplary broker screen for use in systems and methods according to embodiments of the present invention; and

FIG. 10 illustrates an exemplary carrier screen for use in systems and methods according to embodiments of the present invention.

### DETAILED DESCRIPTION OF THE INVENTION

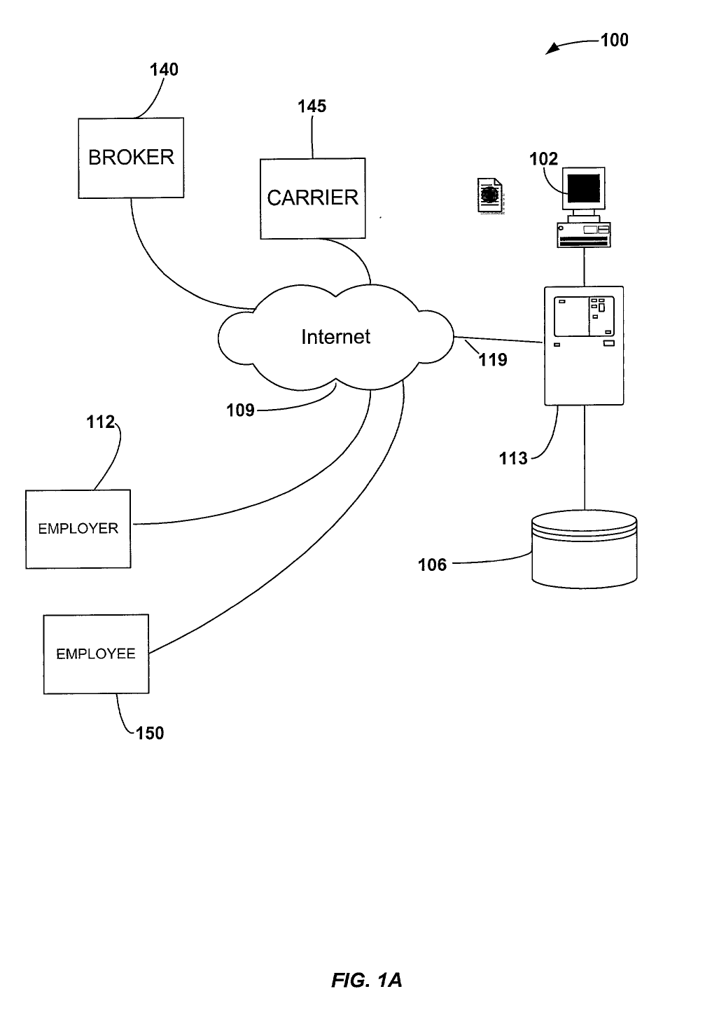

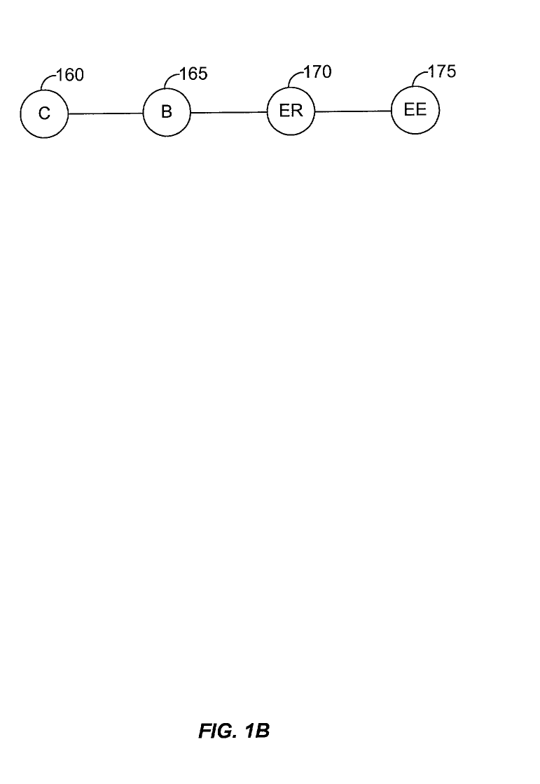

FIG. 1A is a simplified networked environment diagram 100 according to an embodiment of a system for the employee benefits industry of the present invention. This diagram is merely an example, which should not limit the scope of the claims herein. One of ordinary skill in the art would recognize many other variations, modifications, and alternatives. As illustrated therein, the system 100 includes a variety of elements such as a wide area network 109 such as, for example, the Internet, an intranet, or other type of network. Connected to the wide area network 109 is an information server 113, with terminal 102 and database 106. The wide area network allows for communication of other computers such as a client unit 112, broker 140 and carrier 145. Clients can be configured with many different hardware components and can be made in many dimensions, styles and locations (e.g., laptop, palmtop, pen, server, workstation and mainframe).

Terminal 102 is connected to server 113. This connection can be by a network such as Ethernet, asynchronous transfer mode, IEEE standard 1553 bus, modem connection, universal serial bus, and the like. The communication link need not be a wire but can be infrared, radio wave transmission, and the like. Server 113 is coupled 119 to the Internet 109. The Internet is shown symbolically as a cloud or a collection of server routers, computers, and other devices 109. The connection to server is typically by a relatively high bandwidth transmission medium such as a T1 or T3 line, but can also be others.

In certain embodiments, Internet server 113 and database 106 store information and disseminate it to computers e.g., 112, 140, 145, 150 over wide area network 109. The concepts of “client” and “server,” as used in this application and the industry, are very loosely defined and, in fact, are not fixed with respect to machines or software processes executing on the machines. Typically, a server is a machine e.g., 113 or process that is providing information to another machine or process, i.e., the “client,” e.g., 140 that requests the information. In this respect, a computer or process can be acting as a client at one point in time (because it is requesting information) and can be acting as a server at another point in time (because it is providing information). Some computers are consistently referred to as “servers” because they usually act as a repository for a large amount of information that is often requested. For example, a WEB site is often hosted by a server computer with a large storage capacity, high-speed processor and Internet link having the ability to handle many high-bandwidth communication lines.

In a specific embodiment, the network is also coupled to broker 140 using a computer to connect to the server 113 over the Internet by accessing a Web site associated with the system 100. The main system application runs on the server 113. Similarly, an insurance carrier 145 uses a computer to connect to the system 100 over the Internet by accessing the same Web site. A Web browser running on the computer accesses the Web site. Preferably, the Web browser is either the Microsoft Internet Explorer™ Web browser, or the Netscape Navigator™ Web browser. It is understood that the broker 140 is an individual who works for an insurance brokerage firm or for an insurance consulting firm, or who is providing insurance brokerage or consulting services in an individual capacity, so that the term broker 140 includes both insurance brokers and insurance consultants, regardless of the specific type of business organization they operate under. Thus, as used herein, the term “broker” will include both traditional brokers and consultants unless otherwise stated. The carrier 145 is an individual who works for an insurance carrier or provider. The broker 140 and the carrier 145 do not need to be connected to the system 100 at the same time. The system 100 also preferably includes an employer 112 and employee 150.

In certain aspects, the systems and methods of the present invention provide a security handler. The security handler provides authorizing, authenticating and securing communications between the client and server. In certain aspects, the security handler uses end to end encryption accomplished through Secure Sockets Layer (SSL) between the servers and browser based users. In order to perform intrusion prevention and detection functions, the systems and methods are protected by a firewall. A third party performs periodic security audits in order to verify network security practices are up to date and effective.

FIG. 1B shows a preferred embodiment of the connectivity of the system network. Advantageously, using the systems and methods of the present invention, broker 165 similar to broker 140 in FIG. 1A, can increase revenues, lower costs, and improve customer service and retention using the present invention. An efficient system is generated wherein a broker 165 is able to target more products and services to an employee 175 via employer 170 in an efficient workflow environment. Broker 165, carrier 160, employer 170 and employee 175 operate in a streamline workflow process. Moreover, brokers 160 improve customer service and retention as the systems and methods assure accuracy and accessibility of information.

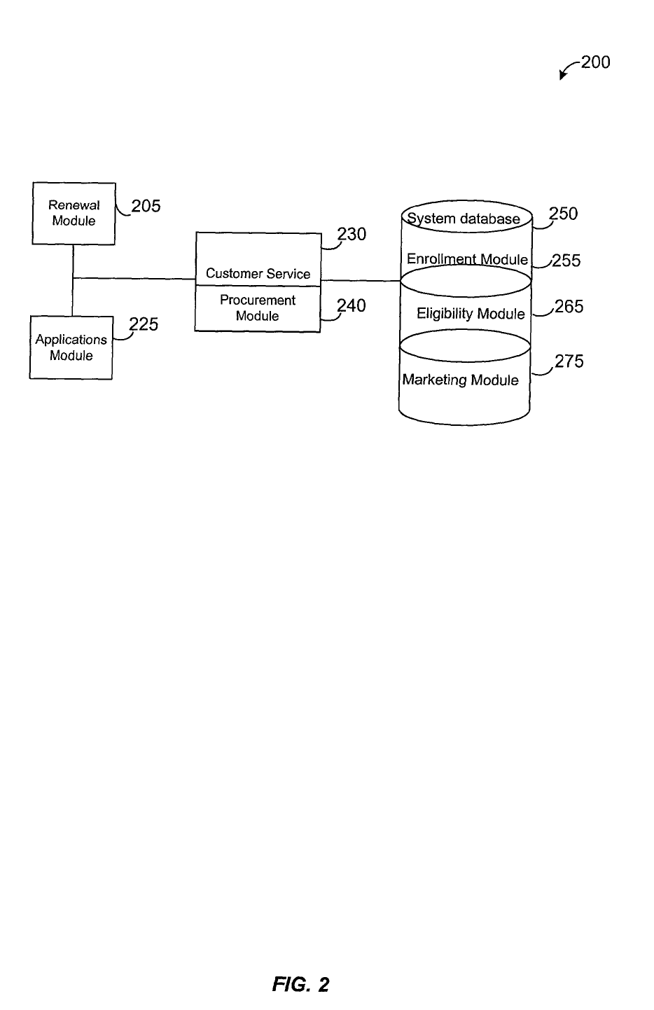

FIG. 2 is a simplified diagram of a system 200 for the employee benefits industry according to an embodiment of the present invention. This diagram is merely an example, which should not limit the scope of the claims herein. One of ordinary skill in the art would recognize many other variations, modifications, and alternatives. A main application runs on the application server such as the server 119 in FIG. 1A. The main application includes a plurality of modules, including a renewal module 205 and an applications module 225. Preferably, the main application is written in Java™ programming language. A system database 250 is coupled to the renewal module 205 for closing and storing the renewal request, making effective the renewed plan and archiving the current plan.

The system can optionally include for example, a customer service or client management module 230, a presale or procurement module 240, a benefits administration and enrollment module 255, a billing and eligibility module 265 and a worksite marketing module 275. In certain aspects, additional modules are operating including, but not limited to, a back office workflow module, a reporting and data mining (analytics) module and a commission and revenue tracking module. In certain preferred aspects, the renewal module is part of a more comprehensive system such as the system disclosed in U.S. patent application Ser. No. 09/714,896, filed Nov. 15, 2000 and Ser. No. 09/917,287, filed Jul. 27, 2001, both of which are hereby incorporated by reference.

As disclosed therein, a broker, like broker 140, enters account information for a client into a main application module. The broker generates a request for proposal (RFP) which contains plans with information (e.g. attributes) that a carrier, like carrier 145, needs to bid on one or more group insurance policies such as a requested plan.

The carrier reviews the RFP and quotes a rate for the requested plan or declines to quote on the requested plan. The broker in conjunction with their employer-client, like employer 112, decides whether or not to purchase the policy.

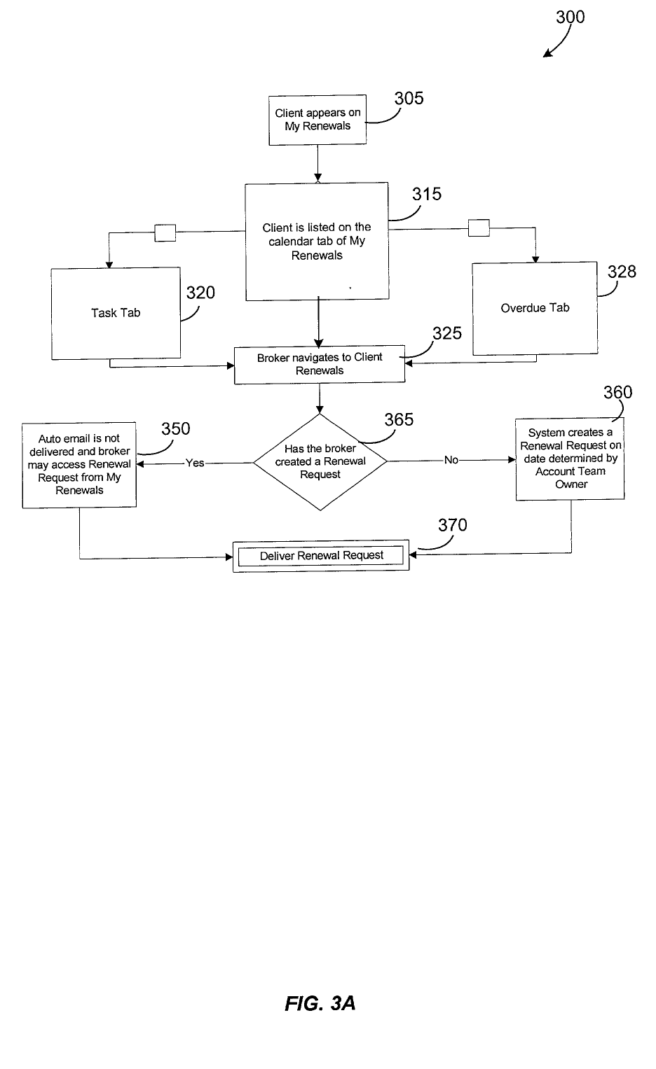

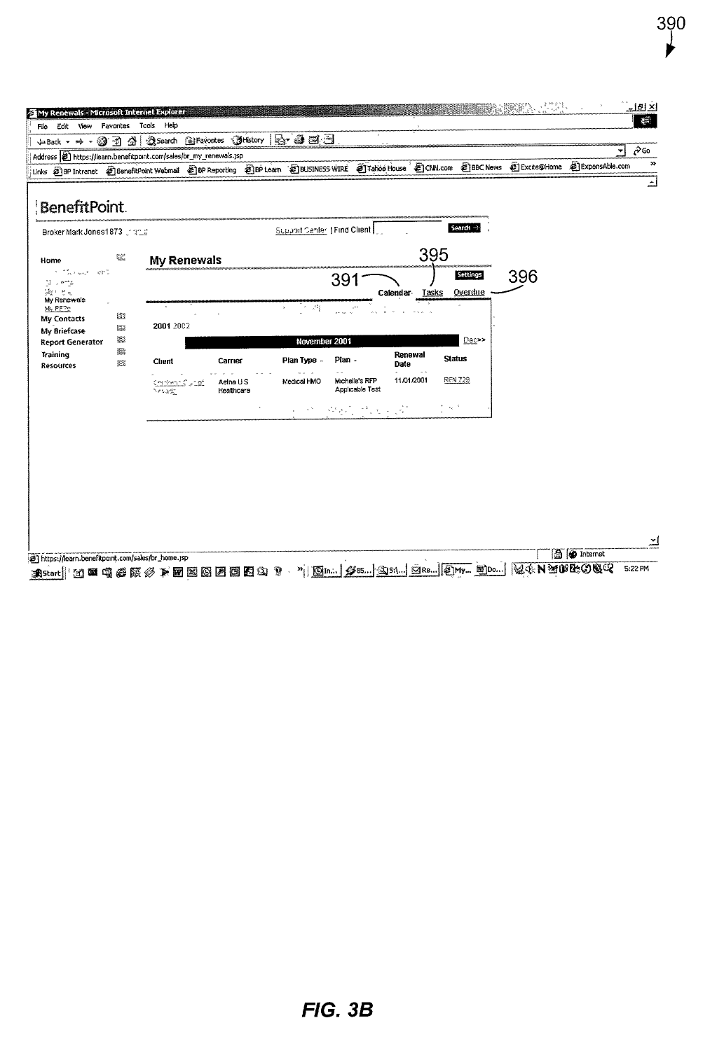

FIG. 3A is a simplified diagram of a system 300 for the employee benefits industry according to an embodiment of the present invention. This diagram is merely an example, which should not limit the scope of the claims herein. One of ordinary skill in the art would recognize many other variations, modifications, and alternatives.

In certain embodiments, the systems and methods of the present invention have two ways for a “renewal request” to be created and delivered to a carrier. As used herein, the phrase “renewal request” means for example, a notification sent to a carrier alerting the carrier to a current plan expiry date. The notification such as an e-mail notification, facsimile transmission or other form of communication, can contain specific renewal information such as renewal rate negotiation, renewal rate procurement and information specific to a current plan.

In one aspect, the systems and methods generate an automatic request (“the system-generated request”). In other aspects, a broker can create a “renewal request” (“broker created request”). The system-generated renewal identifies the recipients of the request and delivers information to the carrier before the expiry of the current plan (e.g., 90 days, 60 days, 45 days and the like before the current plan expiry date). The broker created request allows a broker to optionally customize a request, the information included therein, and determine when the renewal request will be sent to the carrier.

Suitable benefit products include, but are not limited to, medical insurance, dental insurance, vision insurance, life insurance, std insurance, LTD insurance, death benefits, term life insurance, workers compensation, a section 125 plan, a stop loss plan, whole life insurance, variable life insurance, annuities, mutual funds, IRA, travel accident and accidental death and dismemberment, employee assistance programs, individual homeowner's insurance, renter's insurance, auto insurance, umbrella liability insurance, health insurance, non-qualified retirement plans, and 401(k) plan.

System-Generated Delivery

As shown in FIG. 3A, the “My Renewals” web page 305 allows brokers to track renewal functionality. For example, upcoming renewals are placed on a calendar 315, a list of client plans that need attention in the current month is maintained 320, and plans that have passed the renewal date 328, but have not yet been renewed or canceled can be identified. In certain aspects, plans can remain a group plan for thirty days after the renewal date. The new plan (the renewed plan) is current if the effective date is before or equal to the system date, otherwise the plan will remain pending until the effective date. After a time period (e.g., thirty days) the plan will be archived and removed from My Renewals.

All plans coming up for renewal appear on My Renewals' Calendar tab 315. Optionally, the broker can list certain plans on the Tasks Tab 320 as for example, to work on during a certain time period. Plans that are not actively being worked on, but that are overdue appear on the Overdue Tab 328.

The broker navigates to Client Renewals 325. A system-generated “renewal request” is delivered 360 for each client, unless the broker has already created 365 and delivered a request 370. In certain preferred aspects, the brokers is able to define a time frame when the request is to be delivered on a user level. If necessary, the broker can customize that time on a client level. For each client, the account team owner determines when the system-generated e-mail 370 will be delivered.

All members on the broker's account team will be alerted (e.g., 14 days) prior to the system-generated request delivery 360. This alert will appear on the home page and serve as reminder to either update the census or create a request. If the broker does not deliver a renewal request 350, a system-generated renewal request 360 is delivered to carriers based on contacts listed in My Contacts. The system preferably uses the following logic to determine the recipients: a) identify all contacts for the carrier that are listed as renewal contacts for the plan types and market size of plans included in that request. If no contacts are found, then the system will use the default e-mail listed on the Carrier Information Page. If there is no defaulted e-mail, then the e-mail will be sent to the Renewal Owner at the brokerage.

FIG. 3B illustrates a representative broker's “My Renewal” screen 390. The broker, like broker 140 in FIG. 1A, accesses the screen 390 from the main application and views information about the client in a plurality of data entry fields in the screen 390. Some of the fields are drop-down menus that list common likely responses. All plans coming up for renewal appear on the My Renewal Calendar tab 391. The broker can list certain plans and instructions on the Tasks Tab 395 to revisit at some time in the future. Plans that are not actively being worked on, but that are overdue appear on the Overdue Tab 396.

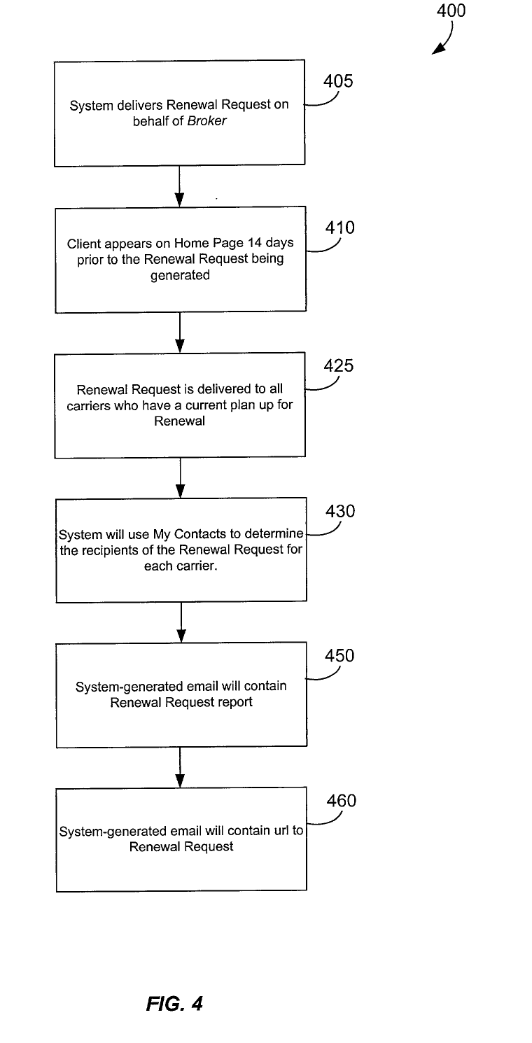

FIG. 4 is a simplified diagram of a system 400 for the employee benefits industry according to an embodiment of the present invention. This diagram is merely an example, which should not limit the scope of the claims herein. One of ordinary skill in the art would recognize many other variations, modifications, and alternatives.

As discussed above, in certain instances, the system delivers a renewal request on behalf of broker. This can occur when the client has a renewal date entered, and that renewal date is for example, 60 days from the system date. If a renewal request has not been created for a client, then a client appears on the Home Page, for example, 14 days prior to the renewal request being generated 410. After the system generates a renewal request, the renewal request is delivered 425 to all carriers who have a current plan up for renewal. After the renewal request is delivered, the system will use My Contacts to determine the recipients of the renewal request 430 for each carrier. For the Non-Connected Carrier or User, the system-generated e-mail will contain a renewal request report 450. For the Connected User, the system-generated e-mail 460 will contain a URL to the renewal request.

In certain preferred instances, a copy of the renewal request is delivered to the account team owner for that client and the default contact for the carrier. The URL and attachments included in the e-mail delivered will be based on the status of the recipient. The different scenarios are set forth in Table I.

TABLE I

| Connected Carrier | Connected Carrier | |
|---|---|---|
| Connected User | Non-Connected User | Non-Connected Carrier |
| URL to “renewal | URL to “renewal | URL to Jump Page |
| request” | request” | |
| | Renewal Report | Renewal Report |
| | Census (If user has | Census (If user has |
| | included it from | included it from |
| | Settings) | Settings) |

The system-generated process creates a renewal request that is populated with at least one of the following fields: client name, brokerage contact (e.g., account team owner), renewal date (e.g., from Plan Info), due date (e.g., seven days from the day the request is delivered); Plans (e.g., all plans that are up for renewal). For all renewal requests, system-generated and broker created, a Renewal ID is generated by the system to uniquely identify it. The delivery information is stored in the Delivery History.

All connected carrier users will be able to access the census (if a census is attached to a client) in the case of a system created renewal request. For non-connected carriers, each broker user determines if the census is to be included as an e-mail attachment. This is defined in the customizations on the “My Renewals” page and applies to the clients for which that broker is the Renewal Owner.

Broker Created Delivery

In certain embodiments, the broker creates the renewal request. If the broker would like to create a renewal request instead of utilizing the system-generated request functionality, the broker can create a request from the Client Renewal page. In one aspect, to create a new renewal request, the broker identifies the current plans to be included, enters carrier specific instructions, and then goes to the Renewal Request Summary. The Renewal Request Summary allows the broker to access the census, attach proposals, and questionnaire, view the benefit summary, plan info (e.g., Eligibility Rules), and rates for the current plans, renewal messages, and the like and then deliver the request.

To deliver, the broker simply clicks “deliver” and goes to the renewal request delivery page. The broker can select the carriers and plans to deliver and click “deliver.” In certain instances, the broker views a delivery confirmation page that is accessed only when a renewal is delivered. A delivery history page maintains a log of all delivery information.

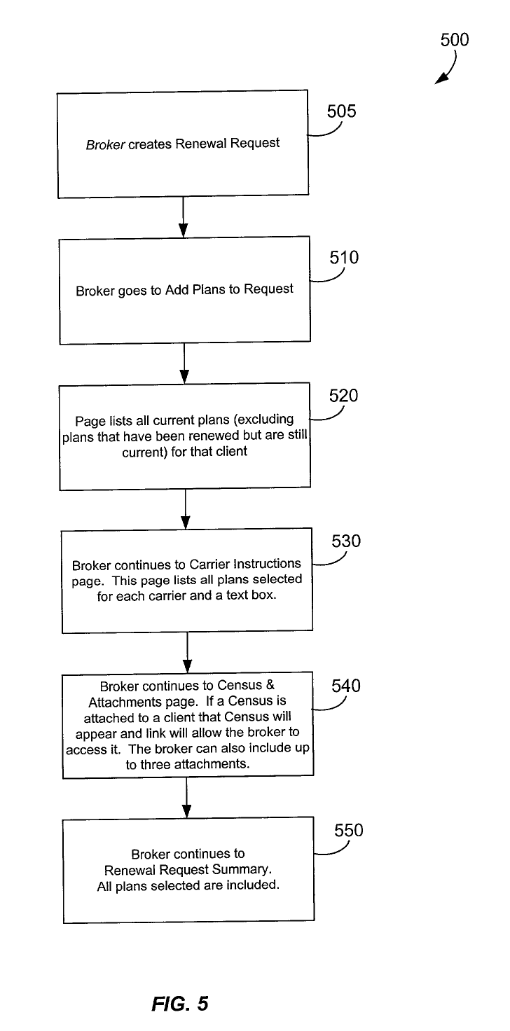

FIG. 5 is a simplified diagram of a system 500 for the employee benefits industry according to an embodiment of the present invention. This diagram is merely an example, which should not limit the scope of the claims herein. One of ordinary skill in the art would recognize many other variations, modifications, and alternatives.

In one specific embodiment, the broker creates a renewal request 505, from the “My Renewals” web page. As shown therein, the broker has navigated to Client Renewals screen and then clicks “create.” The broker goes to Add Plans to Request 510. This page will list all current plans optionally excluding plans that have been renewed, but are still current for that client 520. The broker selects a plan and clicks “continue,” and then the broker continues to the carrier instructions page. This page lists all plans selected for each carrier and a text box 530 and enters a due date for the renewal request. The broker enters instructions and clicks “continue” and then the broker continues to a census & attachments page. If a census is attached to a client that census will appear and link will allow the broker to access it. The broker can also include attachments 540. Thereafter, the broker verifies the census and includes attachments and clicks “finish”. The broker continues to Renewal Request Summary page 550.

In certain preferred aspects, the request is available to all connected carriers to whom the request is delivered and any teams to which those carrier users belong. The request is available to users with Office, Region, or All access at the carrier. A system-generated e-mail will be delivered. The content of the e-mail that is sent when a request is delivered is based on the status of the carrier user receiving the renewal request. The different scenarios are set forth in Table II.

TABLE II

| Connected Carrier | Connected Carrier | |
|---|---|---|
| Connected User | Non-Connected User | Non-Connected Carrier |
| URL to “renewal | URL to “renewal | URL to Jump Page |
| request” | request” | |
| | Census* | Census* |
| | Renewal Report | Renewal Report |
| | Attachments* | Attachments* |

*The Census and Attachments are included only if attached to the “renewal request”

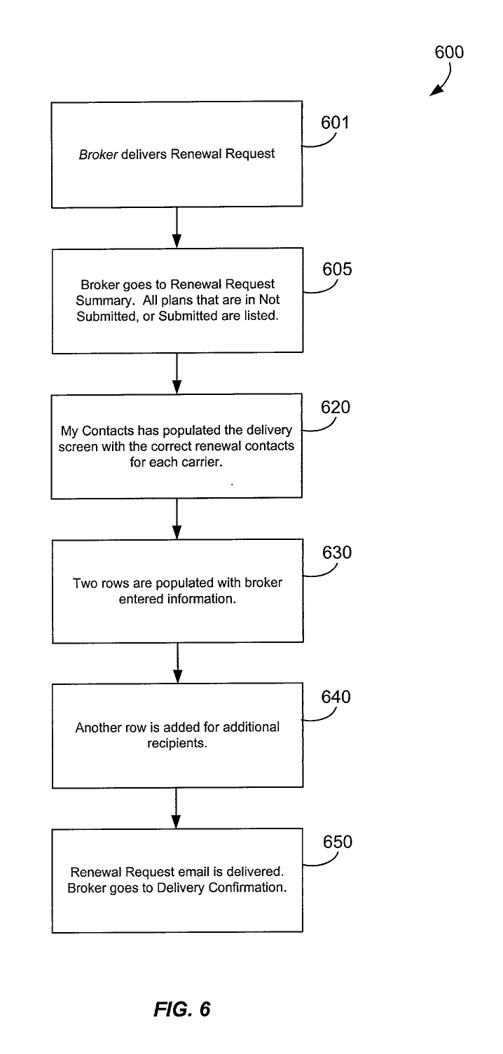

FIG. 6 is a simplified diagram of a system 600 for the employee benefits industry according to an embodiment of the present invention. This diagram is merely an example, which should not limit the scope of the claims herein. One of ordinary skill in the art would recognize many other variations, modifications, and alternatives.

In one specific embodiment, the broker delivers the renewal request 601. In this instance, the renewal request has been created and at least one plan has been added. Next, the broker clicks “deliver” from the “Renewal Request Summary”. Thereafter, the broker goes to “Renewal Request Summary” 605. All plans that are in Not Submitted, or Submitted are listed. There, the broker selects recipients for delivery. “My Contacts” has populated the delivery screen with the correct renewal contacts for each carrier 620. Here, the broker can enter additional recipients. In certain instances, two rows are populated with broker entered information 630. The broker can add recipients, and another row is added for additional recipients 640. After the broker selects the carrier and plans to be delivered and clicks deliver, the renewal request e-mail is delivered 650. Thereafter, the broker goes to delivery confirmation.

Post-Delivery

Once a renewal request is delivered (e.g., by the system, the broker, and the like), that request can be accessed from the Client Renewals page. Advantageously, the broker can make modifications to the request and redeliver the request at any time while the renewal is still open. The broker is able to deliver a Modified renewal request notification. The broker can compare the current plan with any carrier suggested plan, as well as compare current rates to any renewal rates (comparisons are available prior to delivery).

The carrier receives a renewal request e-mail for system-generated and broker created renewal requests. If the carrier user is a connected user, the e-mail will contain a URL leading to the Renewal Request Summary for that client. The carrier user will click on this link, login, and access the “renewal request”.

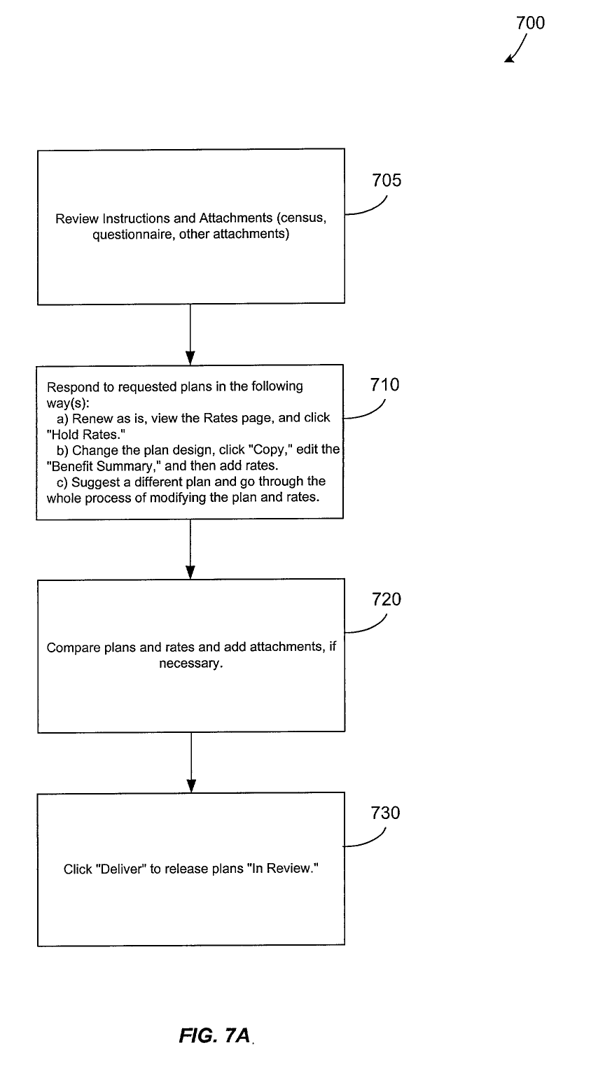

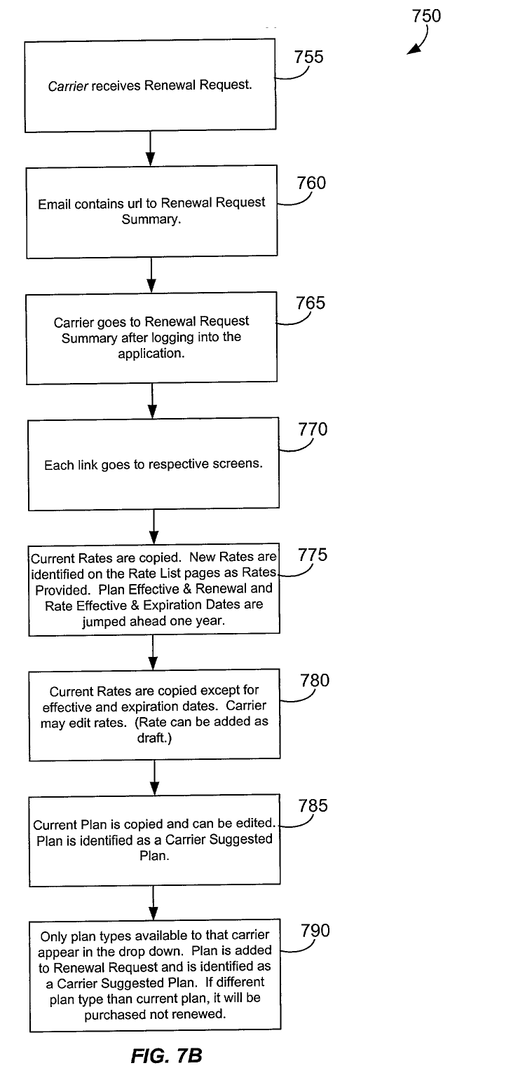

FIG. 7A is a simplified diagram of a system 700 for the employee benefits industry according to an embodiment of the present invention. This diagram is merely an example, which should not limit the scope of the claims herein. One of ordinary skill in the art would recognize many other variations, modifications, and alternatives.

Upon receipt, the carrier will review instructions and attachments 705 (e.g., census, questionnaire, other attachments). The carrier responds 710 to the requested plans in for example, the following way(s): a) Renew as is, view the Rates page, and click “Hold Rates”; b) Change the plan design, click “Copy,” edit the “Benefit Summary,” and then add rates; and c) Suggest a different plan and go through the whole process of modifying the plan and rates. Thereafter, compare plans 720 and rates and add attachments, if necessary. Finally, click “deliver” to release plans 730 “In Review.”

For system-generated and broker created renewal requests, the carrier will view the same renewal request page. As shown therein, the plans that a carrier sees will be those plans selected by the broker on the Delivery Page, if the broker created the request. If the request was system-generated, all current plans with the same renewal date for that carrier will be available. A carrier can view for example, the Benefit Summary, Plan Info (including Eligibility Rules), Rates, and Renewal Messages for each plan. In one aspect, the Current Plan pages are viewable. A carrier is able to view the census if a census is attached. In certain aspects, if the broker has created the renewal request, the carrier is able to view attachments the broker has included. Further, the carrier is able to view the Account Info and the Account Team for each client, unless that Account Team has been hidden.

In responding to renewal request, the carrier is able to hold rates, provide rates or Benefit Summary changes, and/or suggest additional plans. In order to hold rates, the carriers (or brokers quoting on behalf of Non-Connected Carriers) will click “Hold Rates”. This will make a copy of the current rates and jump the “Rate Effective Date” and “Rate Expiration Date” up one year. In certain aspects, a pop-up will alert the user that these dates are jumped ahead (e.g., a year).

In order to provide rates for a plan with Rate changes, the Carriers (or brokers quoting on behalf of Non-Connected Carriers) can click Copy on Rate List. In this instance, the current rates will be copied without the Rate Effective Date and Expiration Date. After selecting copy, the carrier will go directly into the Rate edit page and enter the new effective and expiration dates.

In instances wherein the carrier provides rates for a plan with Benefit Summary changes the carriers will click copy on the plan to be modified. The carriers will edit the necessary attributes. The carriers will click “Add New Rate” from the Rate List. This plan will be identified as a Carrier Suggested Plan. If the carrier wishes to suggest optional plans, the Carrier can search the product library (which can optionally be restricted to plan types available for that carrier). These plans can be added as optional plans and are editable. Carriers can enter the new plan effective date and renewal date on the Plan Info page.

Advantageously, in addition to providing plan and rate information, the carrier is able to do the following: 1. Include up to three attachments per “renewal request”; 2. Compare plans and rates of all plans on a “renewal request”; and 3. Deliver a modified “renewal request” notification.

FIG. 7B is a simplified diagram of a system 750 for the employee benefits industry according to an embodiment of the present invention. This diagram is merely an example, which should not limit the scope of the claims herein. One of ordinary skill in the art would recognize many other variations, modifications, and alternatives.

In one specific embodiment, the broker has created a renewal request and delivered it. The carrier then receives the renewal request 755. In one aspect, the carrier receives an e-mail notifying them of a renewal request. Preferably, the e-mail contains a URL to Renewal Request Summary 760. The carrier clicks the URL in the e-mail and the carrier goes to Renewal Request Summary after logging in to the application 765. The carrier responds after reviewing the Benefit Summary, Plan Info, Rates, Objective, Census, and Attachments. Each link goes to respective screens 770. If the carrier wishes for example, to hold rates, the carrier clicks “Hold Rates” from the Rate List, and the current rates are copied 775. The new rates are identified on the rate list pages. Thereafter, the plan dates are jumped ahead one year. When the carrier copies the current rate, the current rates are copied except for the effective and expiration dates. In certain aspects, the carrier can edit rates 780. In addition, the carrier copies the current plan. Thus, the current plan is copied 785 and can be edited. The plan is identified as a Carrier Suggested Plan. The carrier can suggest an optional plan design by clicking “Add” and searching the Product Library. Plan types available to that carrier appear in the drop down. A plan is added to renewal request and is identified as a Carrier Suggested Plan 790. If the plan is a different plan type than the current plan, it can be purchased.

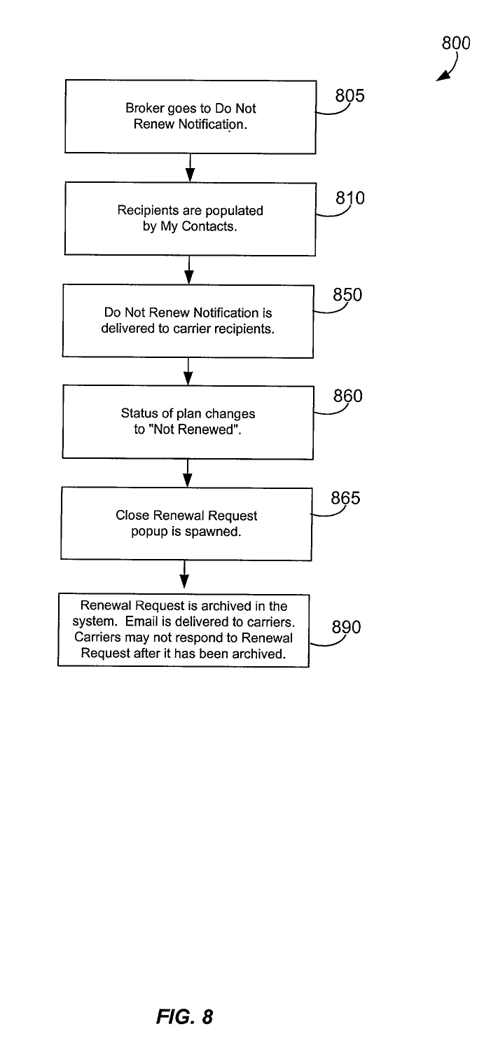

FIG. 8 is a simplified diagram of a system 800 for the employee benefits industry according to an embodiment of the present invention. This diagram is merely an example, which should not limit the scope of the claims herein. One of ordinary skill in the art would recognize many other variations, modifications, and alternatives.

The broker can decline the carrier's plan or rate. For example, if the carrier has added rates to the plan and broker has navigated to the Rate List page, the broker is able to decline the plan. The broker clicks Do Not Renew 805 from the Rate List page. Next, the broker selects and/or adds recipients. and the recipients are populated by My Contacts 810. In the next step, the broker clicks “send,” and the “Do Not Renew Notification” is delivered to the carrier recipients 850. The broker reviews “Notification Confirmation” and clicks Return to Renewal Request, and the status of plan changes to Broker Declined 860.

If the renewal request has been created and at least one plan has been delivered, then the broker clicks “Close” from Renewal Request Summary. The close renewal request “popup” is spawned 865. The broker then clicks “Yes” from the popup. Thereafter, the renewal request is archived in the system 890. An e-mail is delivered to carriers.

Status and Plan Status

A renewal request can have various statuses in the methods and systems. For example, a renewal request will have a status of Not Submitted (broker has not delivered the request to a carrier), Submitted (broker has delivered the request to a carrier), or Closed. A plan within a renewal request will have a status of Not Submitted, Submitted, Renewed, Purchased, Not Renewed, Rates Provided, and Broker Declined. Non-Connected Carriers/Users

If a broker (or the system) delivers an e-mail to a Non-Connected Carrier/User, that user can receive a report. This report will contain for example, all of the information in the renewal request. The broker receives the renewal information outside of the application from Non-Connected Carrier/Users. The broker enters that information into the system before renewing the plan. Brokers can also add plans that a Non-Connected Carrier/User has sent with the renewal. For example, a carrier can provide renewal rates for an LTD plan that are dependent on the purchase of Group Life. Carrier Suggested plans of a different plan type than the current plan will have a purchase link instead of a renew link. A broker has the same options a carrier has to add rates (i.e., holding rates, copying rates).

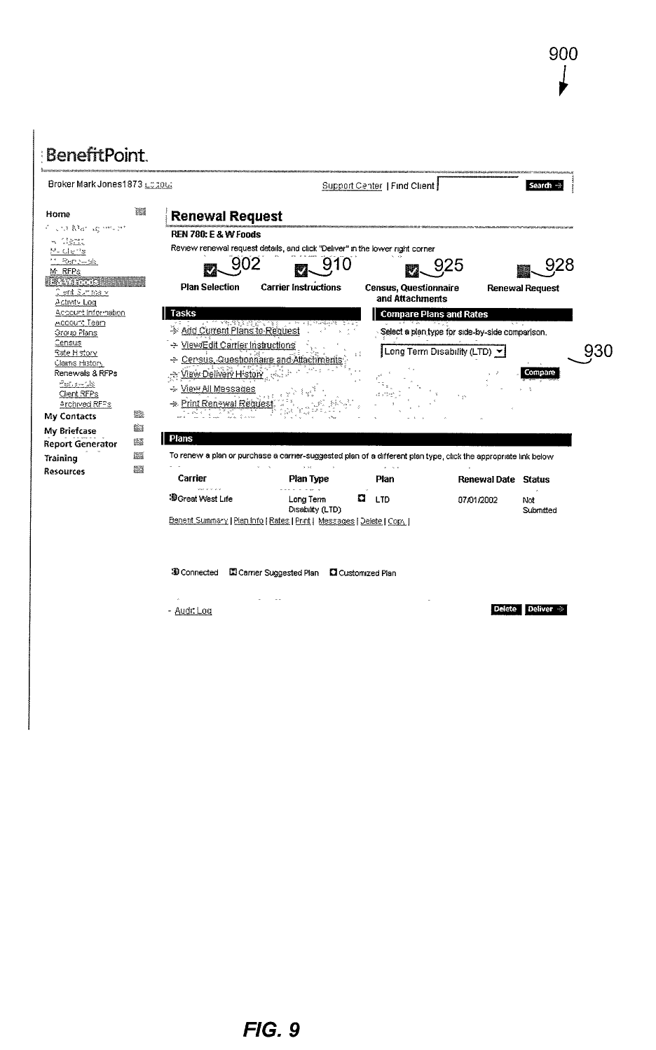

FIG. 9 illustrates an exemplary broker screen 900 used in the methods and systems of the present invention. The screen includes a plurality of data entry fields in which the broker views and enters information as well as a plurality of buttons used to select responses to questions.

For example, as shown therein, the checklist display boxes 902, 910, 925 indicate that the current plan 902 is attached, the carrier instructions 910 are attached, a census 925, a questionnaire, an attachment and combinations thereof, are included with the renewal request. The screen has for example, a drop down menu 930 with various benefit products allowing comparison of rates and features. When the display box 928 is checked, the renewal request is ready to send to the carrier.

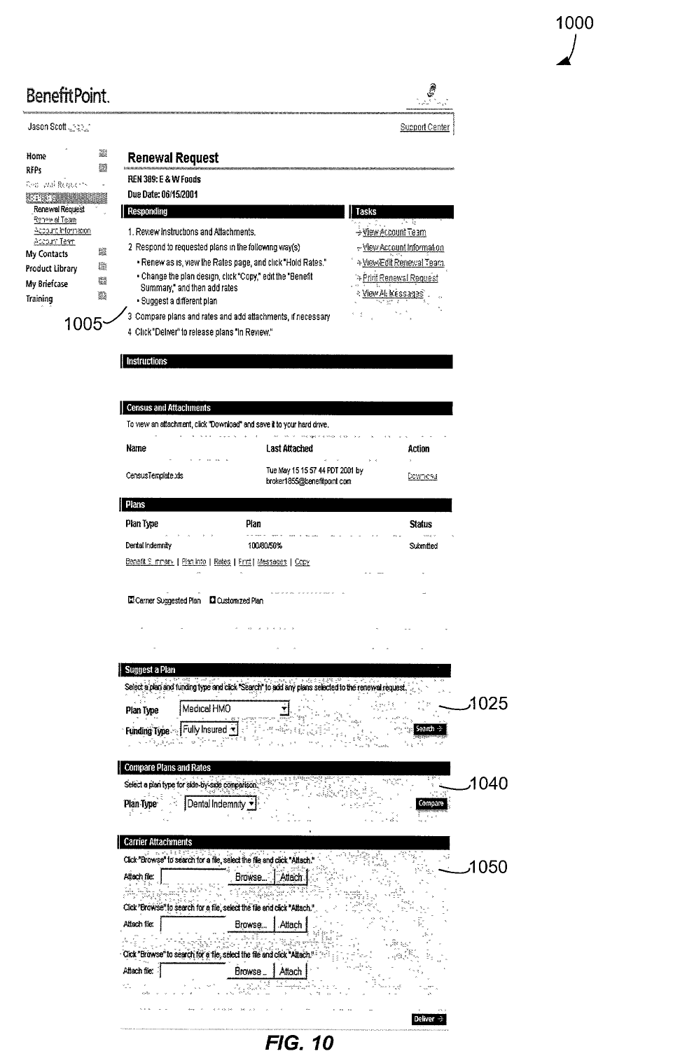

FIG. 10 illustrates an exemplary carrier screen 1000 used in the methods and systems of the present invention. The screen include a plurality of data entry fields in which the carrier views and enters information as well as a plurality of buttons used to select responses to questions.

As shown therein, the carrier screen 1000 has a list of instructions for the carrier 1005 in responding to the renewal request. Advantageously, the screen allows easy access to alternative plans for the carrier to suggest 1025 and facilitates comparison of plans and rates 1040. The carrier can also attach files for the broker to review 1050.

While the invention has been described with reference to certain illustrated embodiments this description is not intended to be construed in a limiting sense. For example, the computer platform used to implement the above embodiments include 586 class based computers, Power PC based computers, Digital ALPHA based computers, SunMicrosystems SPARC computers, and the like; computer operating systems may include WINDOWS NT, DOS, MacOs, UNIX, VMS, and the like; programming languages may include C, C++, Pascal, an object-oriented language, JAVA and the like.

A number of the above processes can be separated or combined into hardware, software, or both and the various embodiments described should not be limiting. As will be appreciated by one of skill in the art, the present invention can be embodied as a method, data processing system, or computer program product. Accordingly, the present invention can take the form of an entirely hardware embodiment, an entirely software embodiment or an embodiment combining software and hardware aspects. Furthermore, the present invention can take the form of a computer program product on a computer-usable storage medium having computer-usable program code embodied in the medium. Any suitable computer readable medium can be utilized including hard disks, CD-ROMs, optical storage devices, or magnetic storage devices. It will be understood, therefore that the invention is defined not by the above description, but by the appended claims. All publications, patents, and patent applications cited herein are hereby incorporated by reference for all purposes in their entirety.

What is claimed is:

1. A computer-implemented method for renewing a benefit product, said method comprising:
providing a carrier with a renewal request for a current benefit plan, wherein said current plan includes current plan information;
responding to a broker by providing a renewed plan;
saving said renewed plan by said broker in a system database, thereby archiving said current plan and renewing said benefit product.

2. The computer-implemented method for renewing a benefit product of claim 1, wherein said current plan information has at least one member of the group consisting of a benefit summary, a specific plan information, an eligibility rule, a rate and a message.

3. The computer-implemented method for renewing a benefit product of claim 1, wherein said renewed plan has at least one member of the group consisting of an updated plan information, an updated rate information, or no changes at all, to the current plan.

4. The computer-implemented method for renewing a benefit product of claim 1, wherein said renewal request is generated by said broker.

5. The computer-implemented method for renewing a benefit product of claim 1, wherein said renewal request is generated by a system.

6. The computer-implemented method for renewing a benefit product of claim 1, wherein said renewal request comprises an e-mail message to a carrier containing a URL leading to a renewal request summary for a client.

7. The computer-implemented method for renewing a benefit product of claim 4, wherein said renewal request comprises plans selected by said broker, a due date, a carrier instruction and a file attachment.

8. The computer-implemented method for renewing a benefit product of claim 5, wherein said renewal request comprises all current plans up for renewal.

9. The computer-implemented method for renewing a benefit product of claim 6, wherein said renewal request summary comprises a census and attachment for said client.

10. The computer-implemented method for renewing a benefit product of claim 6, wherein said renewal request summary comprises at least one member of the group consisting of a current benefit summary, plan information, rate information and a carrier instruction.

11. The computer-implemented method for renewing a benefit product of claim 1, wherein said renewed plan provides a change in rate of said benefit product.

12. The computer-implemented method for renewing a benefit product of claim 1, wherein said renewed plan provides a change in benefit summary and plan information of said benefit product.

13. The computer-implemented method for renewing a benefit product of claim 1, wherein said carrier and said broker negotiate said renewed plan.

14. The computer-implemented method for renewing a benefit product of claim 1, wherein said benefit product is selected from the group consisting of medical insurance, dental insurance, vision insurance, life insurance, std insurance, LTD insurance, death benefits, term life insurance, workers compensation, a section 125 plan, a stop loss plan, whole life insurance, variable life insurance, annuities, mutual funds, IRA, travel accident and accidental death and dismemberment, employee assistance programs, individual homeowner's insurance, renter's insurance, auto insurance, umbrella liability insurance, health insurance, non-qualified retirement plans, and 401(k) plan.

15. The computer-implemented method for renewing a benefit product of claim 4, wherein said renewal request is tracked by said broker prior to sending to said carrier.

16. A system for renewing a benefit product, said system comprising:
a renewal module for sending a carrier a renewal request having a current plan having plan information, wherein said carrier renews said current plan by updating said plan information to generate a renewed plan accessible by a broker; and
a system database coupled to said renewal module for closing said renewal request, making effective said renewed plan and archiving said current plan.

17. The system for renewing a benefit product of claim 16, wherein said archiving of said current plan is 30 days after said renewed plan is effective.

18. The system for renewing a benefit product of claim 16, wherein said current plan comprises a benefit summary, plan information, eligibility rules, rates and messages.

19. The system for renewing a benefit product of claim 16, wherein said renewal request is generated by a broker.

20. The system for renewing a benefit product of claim 16, wherein said renewal request is generated by said system.

21. The system for renewing a benefit product of claim 16, wherein said renewal request comprises an e-mail message to a carrier containing a URL leading to a renewal request summary for a client.

22. The system for renewing a benefit product of claim 16, wherein said carrier and said broker negotiate said renewed plan.

23. The system for renewing a benefit product of claim 16, wherein said benefit product is selected from the group consisting of medical insurance, dental insurance, vision insurance, life insurance, std insurance, LTD insurance, death benefits, term life insurance, workers compensation, a section 125 plan, a stop loss plan, whole life insurance, variable life insurance, annuities, mutual funds, IRA, travel accident and accidental death and dismemberment, employee assistance programs, individual homeowner's insurance, renter's insurance, auto insurance, umbrella liability insurance, health insurance, non-qualified retirement plans, and 401(k) plan.
